(19) United States
(12) Patent Application Publication
(10) Pub. No.: US 2017/0254473 A1
(43) Pub. Date: Sep. 7, 2017

(54) GIMBALS

(71) Applicant: Cloud Cap Technology, Inc., Hood River, OR (US)

(72) Inventor: Gene I. Katz, Parkdale, OR (US)

(21) Appl. No.: 15/062,780

(22) Filed: Mar. 7, 2016

(51) Int. Cl. F16M 13/02; B64D 43/00

(52) U.S. Cl. CPC F16M 13/022; B64D 43/00

(57) ABSTRACT

A gimbal includes a first member, a second member, wherein the first member of the gimbal is rotatably mounted to the second member to be movable relative to a second member of the gimbal about a first rotational axis and a gimbal actuator assembly. The gimbal actuator assembly includes a first portion of an electromagnetic actuator mounted on the first member and a second portion of the electromagnetic actuator mounted on the second member, wherein an electromagnetic interaction of the first portion of the electromagnetic actuator and the second portion of the electromagnetic actuator causes a torque on the first member about the rotational axis.

### BACKGROUND

1. Field

The present disclosure relates to gimbals (e.g., for stabilizing sensors).

2. Description of Related Art

Traditionally, gimbals have rotational electric motors that rotate members of the gimbals about respective axes. These motor types are limited in how small in size and weight they can be due to operational constraints.

Such conventional methods and systems have generally been considered satisfactory for their intended purpose. However, there is still a need in the art for improved gimbals (e.g., with reduced motor size and weight). The present disclosure provides a solution for this need.

### SUMMARY

A gimbal includes a first member, a second member, wherein the first member of the gimbal is rotatably mounted to the second member to be movable relative to a second member of the gimbal about a first rotational axis and a gimbal actuator assembly. The gimbal actuator assembly includes a first portion of an electromagnetic actuator mounted on the first member and a second portion of the electromagnetic actuator mounted on the second member, wherein an electromagnetic interaction of the first portion of the electromagnetic actuator and the second portion of the electromagnetic actuator causes a torque on the first member about the rotational axis.

The first member of the gimbal can be a circular inner platform or any other suitable platform, for example. In certain embodiments, the first portion of the electromagnetic actuator can be positioned 90 degrees about the circular inner platform relative to the first rotational axis. The first portion of the electromagnetic actuator can be a permanent magnet mounted to the first member and the second portion of the electromagnetic actuator can be an electromagnet mounted to the second portion of the electromagnetic actuator such that the electromagnet is in selective electromagnetic communication with the permanent magnet to impart force upon the permanent magnet.

The gimbal can further comprising a third member, wherein the second member of the gimbal can be rotatably mounted to the third member to be movable relative to the third member of the gimbal about a second rotational axis which is different from the first rotational axis. In certain embodiments, the gimbal can further include a fourth member, wherein the third member of the gimbal can be rotatably mounted to the fourth member to be movable relative to the fourth member of the gimbal about a third rotational axis which is different from the first and second rotational axes. In certain embodiments, the first, second, and third rotational axis are orthogonal such that the gimbal can provide three-dimensional motion compensation.

An aircraft sensor system can include an embodiment of a gimbal as described herein and at least one sensor mounted to the first member to stabilize the at least one sensor. In certain embodiments, the sensor can include an imaging device.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an embodiment of a gimbal in accordance with this disclosure, shown having an electromagnetic actuator.

### DETAILED DESCRIPTION

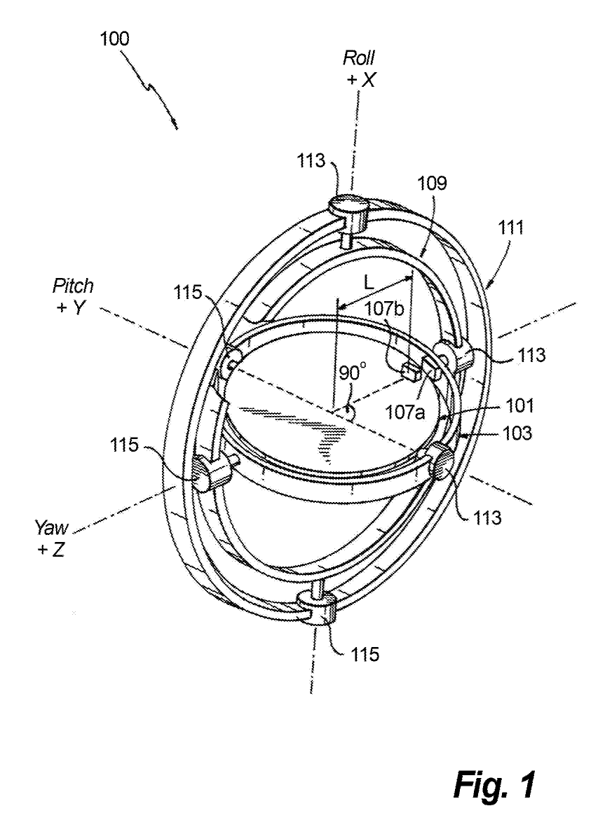

Reference will now be made to the drawings wherein like reference numerals identify similar structural features or aspects of the subject disclosure. For purposes of explanation and illustration, and not limitation, an illustrative view of an embodiment of a gimbal in accordance with the disclosure is shown in FIG. 1 and is designated generally by reference character 100. The systems and methods described herein can be used to provide a gimbal with smaller size and/or lower weight with equal or improved performance over traditional gimbals.

Referring to FIG. 1, a gimbal 100 includes a first member 101, a second member 103. The first member 101 of the gimbal 100 is rotatably mounted (e.g., via one or more pivots 113) to the second member 103 to be movable relative to a second member 103 of the gimbal 100 about a first rotational axis 105.

The gimbal 100 also includes a gimbal actuator assembly. The gimbal actuator assembly includes a first portion 107a of an electromagnetic actuator mounted on the first member 101 and a second portion 107b of the electromagnetic actuator mounted on the second member 103. An electromagnetic interaction of the first portion 107a of the electromagnetic actuator and the second portion 107b of the electromagnetic actuator causes a torque on the first member 101 about the first rotational axis (e.g., pitch axis Y as shown).

As shown, the first member 101 of the gimbal 100 can be a circular inner platform or any other suitable platform, for example (e.g., a rectangular platform). In certain embodiments, the first portion 107a of the electromagnetic actuator can be positioned 90 degrees about the circular inner platform relative to the first rotational axis (e.g., to maximize torque). Any other suitable positioning of the first portion 107a of the electromagnetic actuator is contemplated herein.

In certain embodiments, the first portion 107a of the electromagnetic actuator can be a permanent magnet mounted to the first member 101 and the second portion 107b of the electromagnetic actuator can be an electromagnet (e.g., a coil) mounted to the second portion 105 of the electromagnetic actuator such that the electromagnet is in selective electromagnetic communication with the permanent magnet to impart force upon the permanent magnet. The reverse can be true such that the second portion 107b can be a permanent magnet and the first portion 107a can be an electromagnet. It is contemplated that both the first portion 107a and the second portion 107b can be electromagnets.

The gimbal 100 can further include a third member 109 such that the second member 105 of the gimbal 100 can be rotatably mounted to the third member 109 to be movable relative to the third member 109 of the gimbal 100 about a second rotational axis (e.g., the yaw axis z as shown) which is different from the first rotational axis. As shown, in certain embodiments, the gimbal 100 can further include a fourth member 111. The third member 109 of the gimbal 100 can be rotatably mounted to the fourth member 111 to be movable relative to the fourth member 111 of the gimbal 100 about a third rotational axis (e.g., the roll axis x) which is different from the first and second rotational axes. In certain embodiments, the first, second, and third rotational axis are orthogonal such that the gimbal 100 can provide three-dimensional motion compensation. Any other suitable orientation of the axes is contemplated herein.

It is contemplated that any of the members 101, 103, 109, 111 can be movable via any suitable electromagnetic actuator as described above. For example, each axis of motion can be operated by an electromagnetic actuator, and/or one or more pivots 113 can include a rotational motor as appreciated by those skilled in the art. It is also contemplated that one or more of the members 101, 103, 109, 111 can include a resolver 115 for determining the relative position (e.g., angle of actuation) of an adjacent member.

An aircraft sensor system can include any suitable embodiment of a gimbal 100 as described herein and at least one sensor mounted to the first member to stabilize the at least one sensor. In certain embodiments, the sensor can include an imaging device or any other suitable sensor device.

As described above, using gap torques to couple an inner axis gimbal member to an outer axis structure gives the advantage of the lever ratio rather than the traditional direct drive. Smaller motors can be used, require less power to actuate, and have a higher bandwidth to achieve higher levels of stability, for example.

The methods and systems of the present disclosure, as described above and shown in the drawings, provide for gimbals with superior properties including smaller size and weight, for example. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A gimbal, comprising:
a first member;
a second member, wherein the first member of the gimbal is rotatably mounted to the second member to be movable relative to a second member of the gimbal about a first rotational axis; and
a gimbal actuator assembly, comprising:
a first portion of an electromagnetic actuator mounted on the first member; and
a second portion of the electromagnetic actuator mounted on the second member, wherein an electromagnetic interaction of the first portion of the electromagnetic actuator and the second portion of the electromagnetic actuator causes a torque on the first member about the rotational axis.

2. The gimbal of claim 1, wherein the first member of the gimbal is a circular inner platform.

3. The gimbal of claim 2, wherein the first portion of the electromagnetic actuator is positioned 90 degrees about the circular inner platform relative to the first rotational axis.

4. The gimbal of claim 3, wherein the first portion of the electromagnetic actuator is a permanent magnet mounted to the first member and the second portion of the electromagnetic actuator is an electromagnet mounted to the second portion of the electromagnetic actuator such that the electromagnet is in selective electromagnetic communication with the permanent magnet to impart force upon the permanent magnet.

5. The gimbal of claim 1, further comprising a third member, wherein the second member of the gimbal is rotatably mounted to the third member to be movable relative to the third member of the gimbal about a second rotational axis which is different from the first rotational axis.

6. The gimbal of claim 5, further comprising a fourth member, wherein the third member of the gimbal is rotatably mounted to the fourth member to be movable relative to the fourth member of the gimbal about a third rotational axis which is different from the first and second rotational axes.

7. The gimbal of claim 6, wherein the first, second, and third rotational axis are orthogonal such that the gimbal can provide three-dimensional motion compensation.

8. An aircraft sensor system, comprising:
a gimbal, comprising:
a first member;
a second member, wherein the first member of the gimbal is rotatably mounted to the second member to be movable relative to a second member of the gimbal about a first rotational axis; and
a gimbal actuator assembly, comprising:
a first portion of an electromagnetic actuator mounted on the first member; and
a second portion of the electromagnetic actuator mounted on the second member, wherein an electromagnetic interaction of the first portion of the electromagnetic actuator and the second portion of the electromagnetic actuator causes a torque on the first member about the rotational axis; and
at least one sensor mounted to the first member to stabilize the at least one sensor.

9. The system of claim 8, wherein the first member of the gimbal is a circular inner platform.

10. The system of claim 9, wherein the first portion of the electromagnetic actuator is positioned 90 degrees about the circular inner platform relative to the first rotational axis.

11. The system of claim 10, wherein the first portion of the electromagnetic actuator is a permanent magnet mounted to the first member and the second portion of the electromagnetic actuator is an electromagnet mounted to the second portion of the electromagnetic actuator such that the electromagnet is in selective electromagnetic communication with the permanent magnet to impart force upon the permanent magnet.

12. The system of claim 8, further comprising a third member, wherein the second member of the gimbal is rotatably mounted to the third member to be movable relative to the third member of the gimbal about a second rotational axis which is different from the first rotational axis.

13. The system of claim 12, further comprising a fourth member, wherein the third member of the gimbal is rotatably mounted to the fourth member to be movable relative to the fourth member of the gimbal about a third rotational axis which is different from the first and second rotational axes.

14. The system of claim 13, wherein the first, second, and third rotational axis are orthogonal such that the gimbal can provide three-dimensional motion compensation.

15. The system of claim 8, wherein the sensor includes an imaging device.
